(19) United States
(12) Patent Application Publication
(10) Pub. No.: US 2026/0052060 A1
(43) Pub. Date: Feb. 19, 2026

(54) ADVANCE NETWORK HEALTH OBSERVABILITY

(71) Applicant: Cisco Technology, Inc., San Jose, CA (US)

(72) Inventors: Arash Molavi Kakhki, San Francisco, CA (US); Rinaldo Buratti, San Francisco, CA (US); Xiao Zhang, Durham (CA); Javier Cruz Mota, Lussy-sur-Morges (CH); Federico Lovison, Fontanelle (IT)

(73) Assignee: Cisco Technology, Inc., San Jose, CA (US)

(21) Appl. No.: 18/807,178

(22) Filed: Aug. 16, 2024

(51) Int. Cl. H04L 41/0677; H04L 41/0631; H04L 43/0829; H04L 43/087; H04L 43/0888

(52) U.S. Cl. CPC H04L 41/0677; H04L 41/0631; H04L 43/0829; H04L 43/087; H04L 43/0888

(57) ABSTRACT

In one embodiment, a device detects a performance anomaly in a network based on a plurality of time series of network metrics collected from the network. The device determines a loss of visibility in the network based on results from probing the network. The device identifies a particular location in the network as a root cause of the performance anomaly based on the loss of visibility. The device provides, to a user interface, an indication of the particular location being the root cause of the performance anomaly.

### TECHNICAL FIELD

The present disclosure relates generally to computer networks, and, more particularly, to advance network health observability.

### BACKGROUND

The Internet is a network made up of interconnected smaller networks. Applications and services may be provided across these networks. The resources making up the applications and services and the clients attempting to utilize those resources may be geographically dispersed across the networks. Accordingly, a client may access the geographically dispersed resources across a communication path through the interconnected networks. For example, a client may communicate packets to a geographically dispersed dedicated server of the application or service via a cross-domain network path.

Indeed, the global Internet network is complex, making it difficult to track and monitor the health of each and every network. When a network issue happens, it can manifest in different ways, at different layers, and in different networks (blast radius). More often than not, network operators have educated guesses as to which network(s) or peering connection(s) are exhibiting a problem. However, without sufficient telemetry, the network operator is left with a lack the data to support (or reject) their hypothesis.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of an edge router connecting to a cloud-hosted application via multiple points-of-presence (PoPs);

FIG. 4 illustrates an example architecture for a network observability intelligence platform;

FIGS. 5A-5C illustrate example path trace results;

FIG. 6 illustrates an example plot of healthy traces over time; and

FIG. 7 illustrates an example simplified procedure for identifying a root cause of a performance anomaly in a network.

### DESCRIPTION OF EXAMPLE EMBODIMENTS

### Overview

According to one or more embodiments of the disclosure, a device detects a performance anomaly in a network based on a plurality of time series of network metrics collected from the network. The device determines a loss of visibility in the network based on results from probing the network. The device identifies a particular location in the network as a root cause of the performance anomaly based on the loss of visibility. The device provides, to a user interface, an indication of the particular location being the root cause of the performance anomaly.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

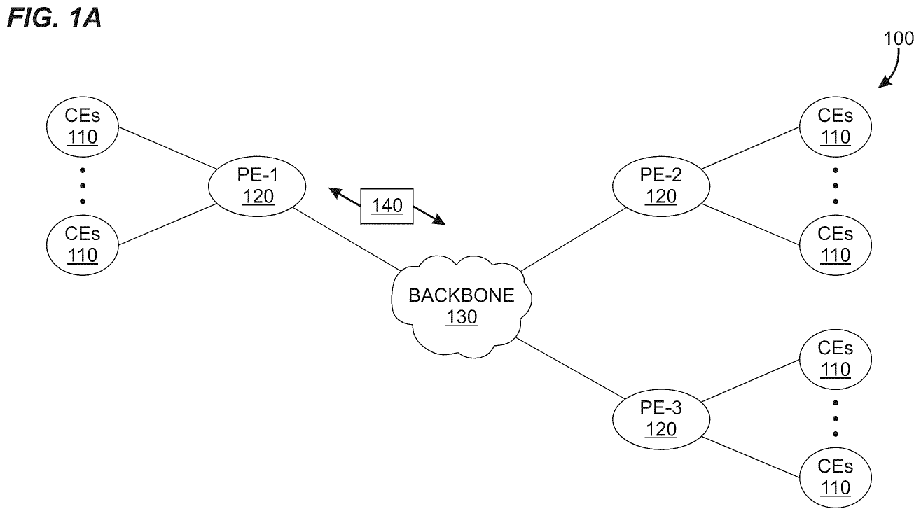

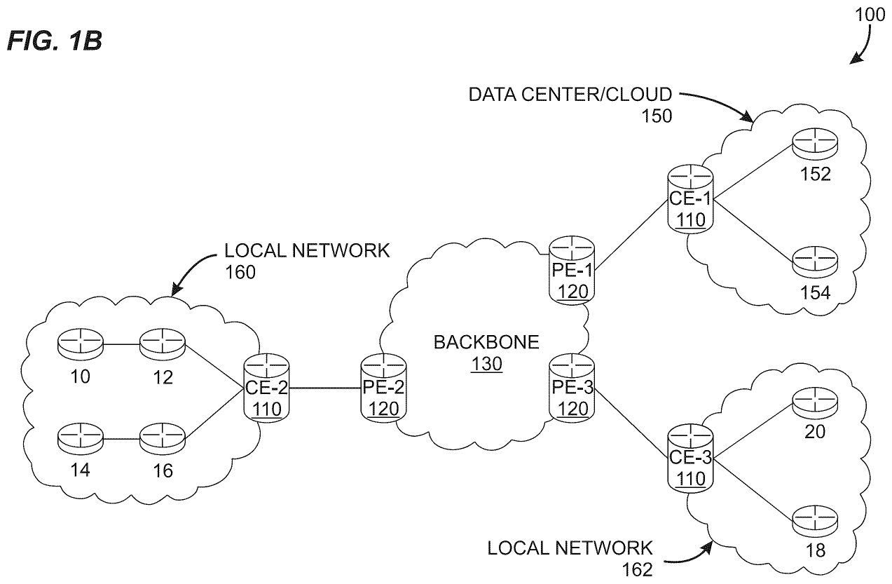

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1) Site Type A: a site connected to the network (e.g., via a private or VPN link) using a single CE router and a single link, with potentially a backup link (e.g., a 3G/4G/5G/LTE backup connection). For example, a particular CE router 110 shown in computer network 100 may support a given customer site, potentially also with a backup link, such as a wireless connection.
2) Site Type B: a site connected to the network by the CE router via two primary links (e.g., from different Service Providers), with potentially a backup link (e.g., a 3G/4G/5G/LTE connection). A site of type B may itself be of different types:
2a) Site Type B1: a site connected to the network using two MPLS VPN links (e.g., from different Service Providers), with potentially a backup link (e.g., a 3G/4G/5G/LTE connection).
2b) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of computer network 100 in greater detail, according to various embodiments. As shown, network backbone 130 may provide connectivity between devices located in different geographical areas and/or different types of local networks. For example, computer network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

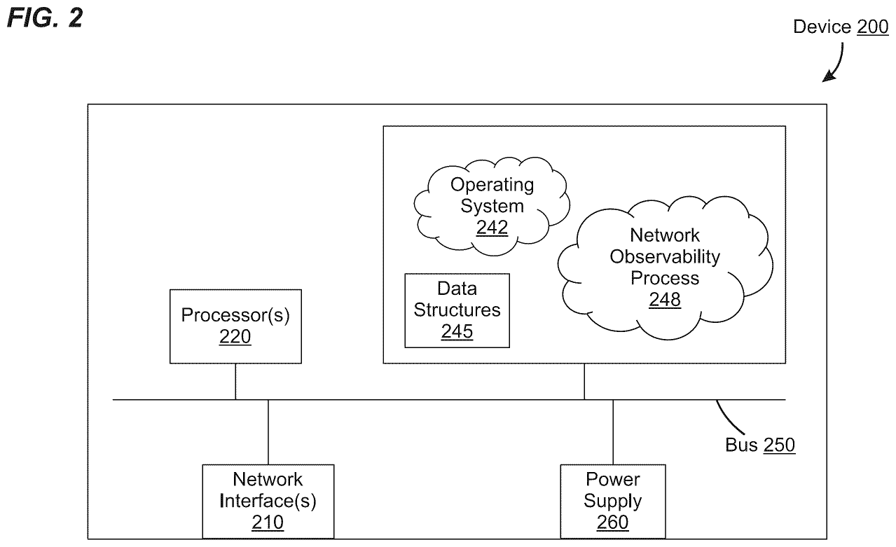

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network observability process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, network observability process 248 may also include computer executable instructions that, when executed by processor(s) 220, cause device 200 to perform the techniques described herein. To do so, in some embodiments, network observability process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network observability process 248 may employ one or more supervised, unsupervised, or semi-supervised machine learning models. Generally, supervised learning entails the use of a training set of data, as noted above, that is used to train the model to apply labels to the input data. For example, the training data may include sample telemetry and/or path performance data that has been labeled as being indicative of a path performance level. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network observability process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further embodiments, network observability process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

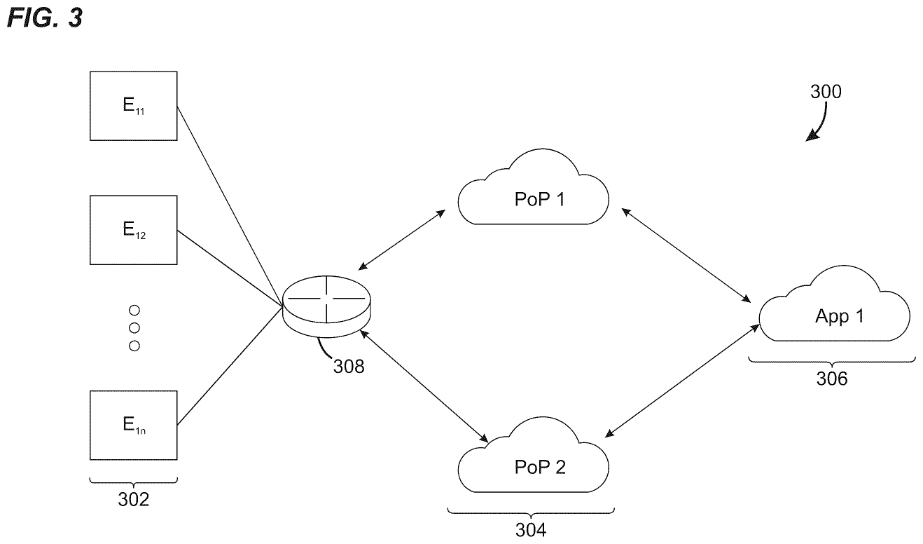

FIG. 3 illustrates an example 300 of an edge router 308 accessing a cloud-hosted application or service 306. As shown, assume that there are n-number of endpoints 302 at a particular location for which edge router 308 provides external connectivity. An online application or service provider may maintain any number of points-of-presence (PoPs), such as PoPs 304, to which edge router 308 may connect. Accordingly, edge router 310 may access a cloud-hosted application or service 306, such as a SaaS application, via a first PoP among PoPs 304, a second PoP among PoPs 304, etc.

However, the network performance when accessing the cloud-hosted application or service 306 via PoPs 304 is not guaranteed. Indeed, ensuring that traffic SLAs are met may require adjustments:
To meet SLAs, exceptions might be required for traffic that should not be sent through the gateway but directly sent via Direct Internet Access (DIA) locally, in case the gateway is not able to provide a good enough performance for a specific kind of traffic, which highly depends on Peering between the Online application or service provider Gateway PoP and SaaS provider or intermediate Autonomous Systems (AS). For instance, it is sometimes recommended to send out VoIP traffic directly DIA to achieve better performance. However, this defeats the purpose of delivering WAN and security directly in the cloud while relying only on a very simple unique tunnel from all locations.
Selection of the “closest PoP” is usually based on either geo-location, AnyCast (e.g., for secure web gateways relying on HTTPS proxies), probing results (e.g., selecting the PoP with the lowest latency), or by fixing a static PoP location (e.g., as is usually done when setting up fixed iPsec tunnels). However, online application or service providers tend to have rather dense sets of PoPs to which a location can connect. Thus, the closest PoP is not always the best one to use, in terms of providing the best possible application experience. In particular, a PoP might be struggling at certain tines of the day to satisfy the SLA of the application traffic, while other nearby PoPs might not.
The performance of a given PoP can also vary between applications. Indeed, performance can be influenced by any or all of the following factors:
   Edge to PoP.
   PoP load.
   PoP to PoP, if traffic is sent through a backbone.
   PoP to SaaS. Different PoPs might have different types of inter-connect or peering with SaaS services and might end up going to different SaaS physical endpoints, even if the SaaS exposes a single logical endpoint.

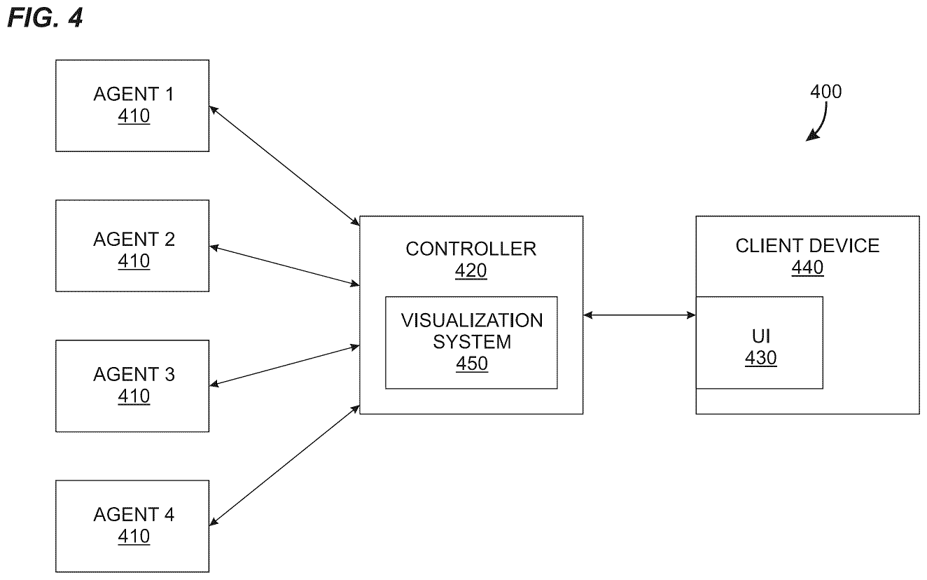

As discussed with respect to illustrative FIG. 4 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 4 is a block diagram of an example observability intelligence platform 400 that can implement one or more aspects of the techniques herein (e.g., through execution of network observability process 248). The observability intelligence platform is a system that monitors and collects metrics of performance data for a network and/or application environment being monitored. At the simplest structure, the observability intelligence platform includes agents 410 (e.g., one or more agents) and one or more servers and/or controllers, such as the controller 420. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 420 (or controllers) as directed. Note that while FIG. 4 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents 410 may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page, i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 420 is the central processing and administration server for the observability intelligence platform. The controller 420 may serve a browser-based user interface (UI), which may be referred to as an interface 430 that is the primary interface for monitoring, analyzing, and troubleshooting the monitored environment. Specifically, the controller 420 can receive data from agents 410 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 430. The interface 430 may be viewed as a web-based interface viewable by a client device 440. In some implementations, a client device 440 can directly communicate with controller 420 to view an interface for monitoring data. The controller 420 can include a visualization system 450 for displaying the reports and dashboards related to the disclosed technology. In some implementations, the visualization system 450 can be implemented in a separate machine (e.g., a server) different from the one hosting the controller 420.

Notably, in an illustrative Software as a Service (SaaS) implementation, an instance of controller 420 may be hosted remotely by a provider of the observability intelligence platform 400. In an illustrative on-premises (On-Prem) implementation, an instance of controller 420 may be installed locally and self-administered.

The controllers 420 receive data from different agents, such as the agents 410 (e.g., Agents 1-4) deployed to monitor networks, applications, databases and database servers, servers, and end user clients for the monitored environment. Any of the agents 410 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (e.g., an application instance) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

As noted above, the global Internet network is complex, making it difficult to track and monitor the health of each and every network. When a network issue happens, it can manifest in different ways, at different layers, and in different networks (blast radius). More often than not, network operators have educated guesses as to which network(s) or peering connection(s) are exhibiting a problem. However, without sufficient telemetry, the network operator is left with a lack the data to support (or reject) their hypothesis.

### Advance Network Health Observability

The techniques herein allow for the identification of the root cause of a performance degradation/anomaly in a computer network, even in instances where the network routes traffic around the problematic location. In various instances, the techniques herein allow a user to have a wholistic view of networks and their connections. In some cases, the user can zoom in and out on networks, and focus on any network and location. Further, the user can focus on any peering, i.e., connection between two networks. In various instances, the techniques herein may also provide health metrics and a composite health score on any network, location, and peering.

Illustratively, the techniques described herein may be performed by hardware, software, and/or firmware, such as in accordance with network observability process 248, which may include computer executable instructions executed by the processor 220 (or independent processor of interfaces 210) to perform functions relating to the techniques described herein.

Specifically, according to various embodiments, a device detects a performance anomaly in a network based on a plurality of time series of network metrics collected from the network. The device determines a loss of visibility in the network based on results from probing the network. The device identifies a particular location in the network as a root cause of the performance anomaly based on the loss of visibility. The device provides, to a user interface, an indication of the particular location being the root cause of the performance anomaly.

Traditionally, network health has been assessed through end-to-end (E2E) and hop-by-hop probes, such as ping and traceroute, to gather critical metrics such as E2E packet loss, latency, jitter, hop-by-hop latencies, throughput, and the exact forwarding path. These metrics serve as the basis for monitoring network integrity and troubleshooting problems. The principle is straightforward: more probes equate to richer data, boosting the likelihood of detecting network anomalies. However, while identifying issues from end-to-end is relatively straightforward, pinpointing the exact root cause of a performance anomaly, such as the specific network at fault, can be challenging.

Current solutions, including ThousandEyes Internet Insights for Network Outages, excel in identifying network problems when the failures appear in the data (e.g., network probes failing inside a network). Yet, more often than not, probes never even reach the real culprit network. Furthermore, many network operation systems are already configured to automatically detect end-to-end problems, rerouting traffic to avoid them. Consequently, visibility into the problematic network segment is reduced precisely when it's most needed for accurate diagnosis.

According to various embodiments, network observability process 248 may leverage machine learning to perform time series analysis on the probing results collected from the network (e.g., via agents 410). For instance, such probing results may be indicative of packet loss, latency, jitter, throughput, or other path performance metrics.

Such analysis may detect instances in which a performance anomaly exists in the network. Suitable anomaly detection approaches that network observability process 248 may use could include autoregressive integrated moving average (ARIMA) modeling, transformer-based multivariate timeseries modeling, long short-term memory (LSTM)-based anomaly detection modeling, or any other suitable machine learning-based approach for anomaly detection. As would be appreciated, solutions relying on a single metric are often very good at detecting one profile of performance degradation but fail at detecting issues that manifest in various different ways at the same time. Indeed, single metric systems often cannot connect different looking failures to the same cause.

In various aspects, network observability process 248 may employ enhanced failure detection by not only identifying signs of network failure but also by monitoring for the sudden or gradual loss of visibility into network segments. Such a loss of visibility is typically a telling indicator for isolating root causes of any degradation. More specifically, E2E metrics do not carry information about where the issue is happening. However, network observability process 248 may instead model and track the distribution of E2E metric successes/failures that crosses a network (e.g., by correlating with hop-by-hop probes). In such a case, a sudden shift in this distribution can help pinpoint the root cause of the issue.

The strategy herein entails network observability process 248 leveraging multiple signals for issue detection, rather than relying on a single indicator, such as an increase in network failures. This includes monitoring the ‘pulse’ or frequency of data points interacting with the network. By establishing baselines and conducting anomaly detection for each metric across networks and applying machine learning to discern the patterns of these anomalies, network observability process 248 can accurately identify and localize the source of network faults. This multi-faceted, machine learning-driven approach promises to revolutionize network health monitoring, providing a more nuanced and actionable understanding of network performance and reliability.

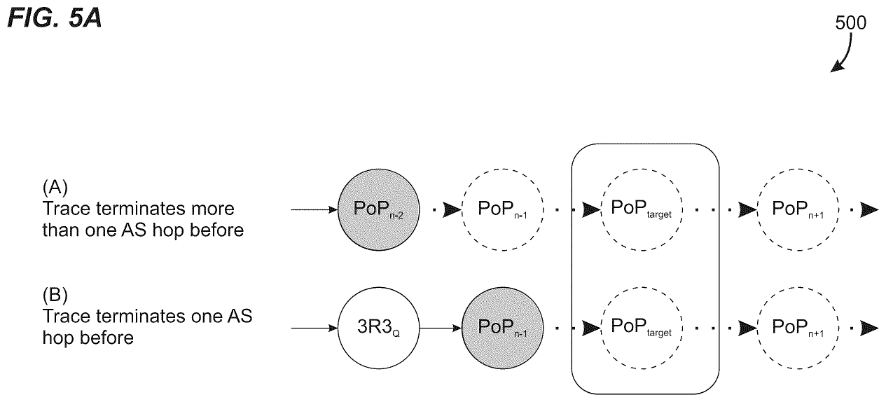

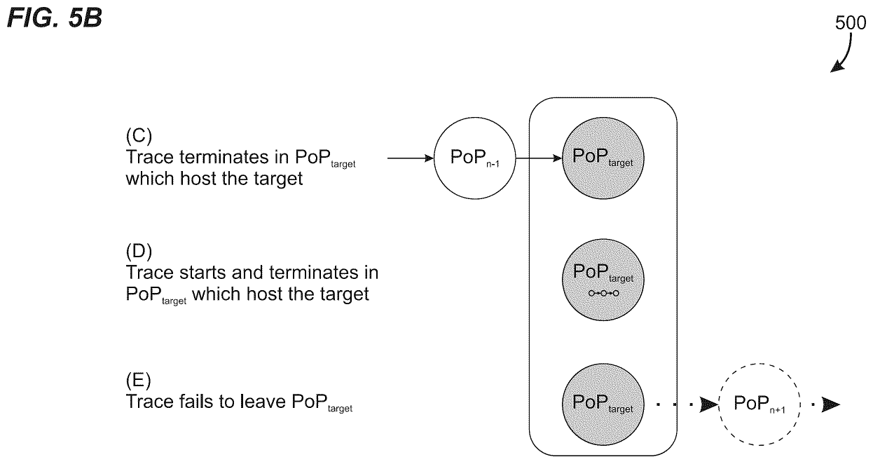

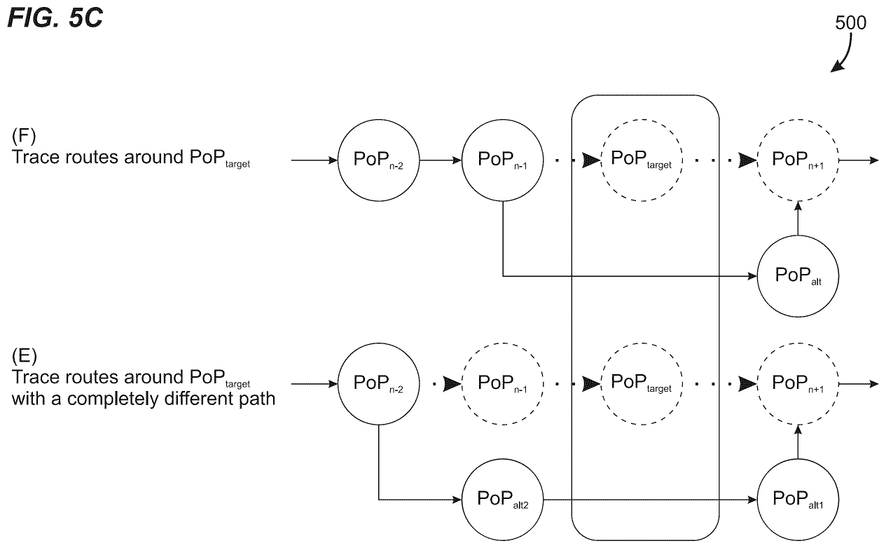

FIGS. 5A-5C illustrate example path trace results, in various instances. As shown in example 500 in FIG. 5A, two cases are show:
(Case A) The path trace terminates more than one autonomous system (AS) before the target PoP.
(Case B) The path trace terminates one AS hop before the target PoP.

In both cases, a traditional approach to root causing networking issues may falsely identify the terminating location of the trace (e.g., PoPₙ₋₂ or PoPₙ₋₁) as the root cause of the performance anomaly.

FIG. 5B illustrates further examples 510 whereby traces terminate in the target PoP, PoP_{target}, in the following cases:
(Case C) The trace terminates in PoP_{target}, which hosts the target of the trace.
(Case D) The trace starts and terminates in PoP_{target}, which hosts the target.
(Case E) The trace fails to leave PoP_{target}.

FIG. 5C illustrates yet additional examples 520 whereby the network reroutes traces around PoP_{target} in the following cases:
(Case F) The trace reaches PoPₙ₋₁, but is routed around PoP_{target} instead to PoPₐₗₜ.
(Case G) The trace reaches PoPₙ₋₂, but is routed around PoP_{target} instead through PoPₐₗₜ₁, along a completely different path.

As in FIG. 5A, examples 520 in FIG. 5C illustrate additional cases in which there is a drop in visibility into the location (PoP_{target}) that is the root cause of the performance anomaly/issue in the network.

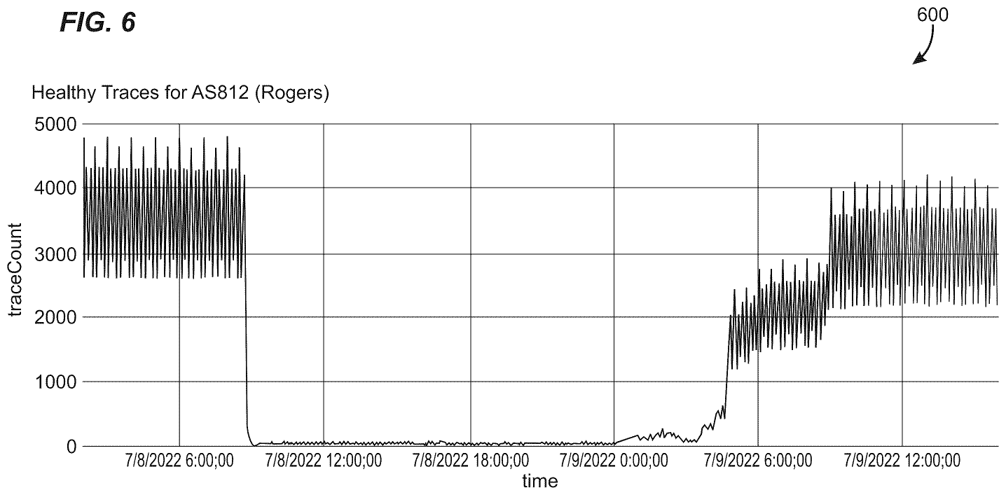

In various implementations, network observability process 248 may quantify the loss of visibility into the various locations (e.g., the PoPs) in the network over time. For instance, FIG. 6 illustrates an example plot 600 of healthy traces over time for a particular location (AS 812—Rogers). Here, the count of healthy traces suddenly drops off to effectively zero for a period of time. By correlating the sudden loss of visibility to this location with a detected performance anomaly, network observability process 248 may determine that this location is the root cause of the performance anomaly.

In turn, network observability process 248 may provide, to a user interface, an indication that the identified location is the root cause of the performance anomaly in the network. For instance, the indication may specify the autonomous system, particular PoP, or the like, that is responsible for the change in performance in the network.

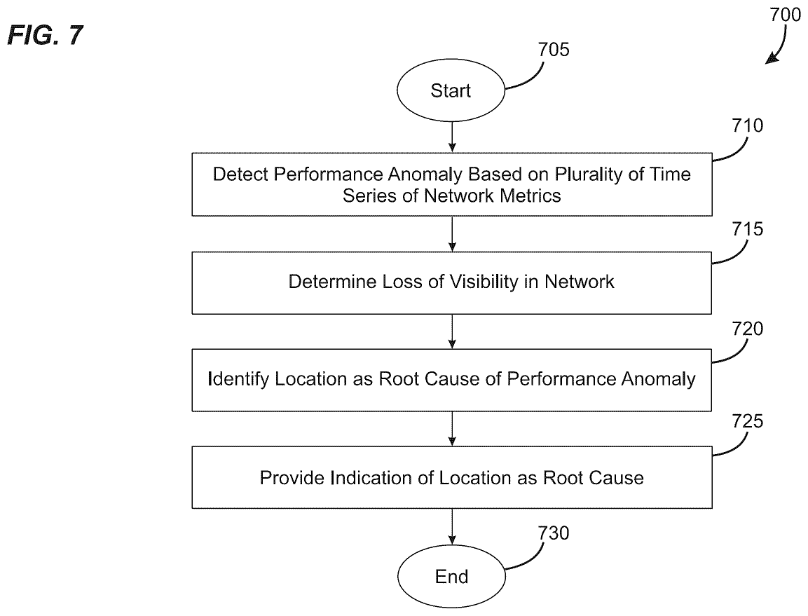

FIG. 7 illustrates an example simplified procedure 700 (e.g., a method) for identifying a root cause of a performance anomaly in a network, in accordance with one or more embodiments described herein. For example, a non-generic, specifically configured device (e.g., device 200) may perform procedure 700 by executing stored instructions (e.g., network observability process 248). The procedure 700 may start at step 705, and continues to step 710, where, as described in greater detail above, the device may detect a performance anomaly in a network based on a plurality of time series of network metrics collected from the network. In various implementations, the device uses machine learning to detect the performance anomaly. For instance, the network metrics may comprise at least one of: latency, packet loss, throughput, or jitter.

At step 715, as detailed above, the device may determine a loss of visibility in the network based on results from probing the network. In some instances, the results from probing the network indicate a path trace failing to leave the particular location in the network. In further cases, wherein the results from probing the network indicate a path trace failing to reach the particular location in the network. In another instance, the results from probing the network indicate a path trace ending at a point in the network prior to the particular location. In a further instance, the results from probing the network indicate traffic in the network being rerouted around the particular location.

At step 720, the device may identify a particular location in the network as a root cause of the performance anomaly based on the loss of visibility, as described in greater detail above. In various cases, the particular location is a point-of-presence (PoP) in the network. In various implementations, the device determines the loss of visibility in the network based on a count of successful or unsuccessful path traces in the network from the results from probing the network. In one implementation, the device identifies the particular location as the root cause by identifying a shift in a distribution of the count of successful or unsuccessful path traces.

At step 725, as detailed above, the device may provide, to a user interface, an indication of the particular location being the root cause of the performance anomaly. In some instances, the indication indicates that the particular location is associated with a particular autonomous system in the network.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments for advance network health observability, it is to be understood that various other adaptations and modifications may be made within the spirit and scope of the embodiments herein. For example, while certain embodiments are described herein with respect to using certain models and network performance metrics for purposes of predicting network path performance, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
detecting, by a device, a performance anomaly in a network based on a plurality of time series of network metrics collected from the network;
determining, by the device, a loss of visibility in the network based on results from probing the network;
identifying, by the device, a particular location in the network as a root cause of the performance anomaly based on the loss of visibility; and
providing, by the device and to a user interface, an indication of the particular location being the root cause of the performance anomaly.

2. The method as in claim 1, wherein the results from probing the network indicate traffic in the network being rerouted around the particular location.

3. The method as in claim 1, wherein the results from probing the network indicate a path trace ending at a point in the network prior to the particular location.

4. The method as in claim 1, wherein the network metrics comprise at least one of: latency, packet loss, throughput, or jitter.

5. The method as in claim 1, wherein the device determines the loss of visibility in the network based on a count of successful or unsuccessful path traces in the network from the results from probing the network.

6. The method as in claim 5, wherein the device identifies the particular location as the root cause by identifying a shift in a distribution of the count of successful or unsuccessful path traces.

7. The method as in claim 1, wherein the results from probing the network indicate a path trace failing to leave the particular location in the network.

8. The method as in claim 1, wherein, wherein the results from probing the network indicate a path trace failing to reach the particular location in the network.

9. The method as in claim 1, wherein the particular location is a point-of-presence (PoP) in the network.

10. The method as in claim 1, wherein the indication indicates that the particular location is associated with a particular autonomous system in the network.

11. An apparatus, comprising:
one or more network interfaces;
a processor coupled to the one or more network interfaces and configured to execute one or more processes; and
a memory configured to store a process that is executable by the processor, the process when executed configured to:
detect a performance anomaly in a network based on a plurality of time series of network metrics collected from the network;
determine a loss of visibility in the network based on results from probing the network;
identify a particular location in the network as a root cause of the performance anomaly based on the loss of visibility; and
provide, to a user interface, an indication of the particular location being the root cause of the performance anomaly.

12. The apparatus as in claim 11, wherein the results from probing the network indicate traffic in the network being rerouted around the particular location.

13. The apparatus as in claim 11, wherein the results from probing the network indicate a path trace ending at a point in the network prior to the particular location.

14. The apparatus as in claim 11, wherein the network metrics comprise at least one of: latency, packet loss, throughput, or jitter.

15. The apparatus as in claim 11, wherein the apparatus determines the loss of visibility in the network based on a count of successful or unsuccessful path traces in the network from the results from probing the network.

16. The apparatus as in claim 15, wherein the apparatus identifies the particular location as the root cause by identifying a shift in a distribution of the count of successful or unsuccessful path traces.

17. The apparatus as in claim 11, wherein the results from probing the network indicate a path trace failing to leave the particular location in the network.

18. The apparatus as in claim 11, wherein the results from probing the network indicate a path trace failing to reach the particular location in the network.

19. The apparatus as in claim 11, wherein the particular location is a point-of-presence (PoP) in the network.

20. A tangible, non-transitory, computer-readable medium storing program instructions that cause a device to execute a process comprising:
detecting, by the device, a performance anomaly in a network based on a plurality of time series of network metrics collected from the network;
determining, by the device, a loss of visibility in the network based on results from probing the network;
identifying, by the device, a particular location in the network as a root cause of the performance anomaly based on the loss of visibility; and
providing, by the device and to a user interface, an indication of the particular location being the root cause of the performance anomaly.
